(19) United States
(12) Patent Application Publication
(10) Pub. No.: US 2006/0225109 A1
(43) Pub. Date: Oct. 5, 2006

(54) Power-saving channel scanning for multi-channel broadcasting

(76) Inventor: Dong-Uk Seo, Cheonan-si (KR)

Correspondence Address: Robert E. Bushnell, Suite 300, 1522 K Street, N.W., Washington, DC, 20005, US

(21) Appl. No.: 11/330,330

(22) Filed: Jan. 12, 2006

(30) Foreign Application Priority Data
Apr. 1, 2005 (KR) 10-2005-0027709

(51) Int. Cl. H04N 7/173; H04N 5/44

(52) U.S. Cl. 725/100; 348/725; 725/131

(57) ABSTRACT

A power-saving channel scanning system and a method thereof for multi-channel broadcasting stops the scanning operation of a digital tuner installed in a broadcast receiving device (Set-Top Box (STB)) and switches to a power-saving mode when a cable is cut off or no signal is received in a multi-channel broadcasting system. The power-saving channel scanning system includes a broadcast receiving terminal measuring broadcasting channel powers in order and switching from a normal mode to a power-saving mode when the powers of all of the measured channels are outside the range of a predetermined normal channel power.

### CLAIM OF PRIORITY

This application makes reference to, incorporates the same herein, and claims all benefits accruing under 35 U.S.C. §119 from an application for POWER-SAVING CHANNEL SCANNING SYSTEM AND METHOD FOR MULTI-CHANNEL BROADCASTING earlier filled in the Korean Intellectual Property Office on 1 Apr. 2005 and there duly assigned Serial No. 2005-27709.

### BACKGROUND OF THE INVENTION

1. Field of the Invention

The present invention relates to a power-saving channel scanning system and method for multi-channel broadcasting, and more particularly, to a power-saving channel scanning system and method for multi-channel broadcasting that stops a scanning operation of a digital tuner installed in a broadcast receiving device (Set-Top Box (STB)) and switches to a power-saving mode when a cable is cut off or no signal is received.

2. Description of Related Art

At present, in the early stages of digital broadcasting service, the number of digital and analog channels broadcasting via a terrestrial transmitter, a cable, a satellite, etc. has exceeded 100 channels. In order to receive so many channels, a digital tuner is required.

A digital tuner is a receiving tuner that can receive digital satellite broadcasting directly rather than via a relay station. The digital tuner has the advantages of high definition, high fidelity, and audio broadcasting capability, and overcomes difficulties in reception. Such a digital tuner can be installed in a Set-Top Box (STB) or a television (TV).

The Downstream Power Monitoring (DPM) function that monitors the reception power level of a downstream signal is disclosed in the standard, Data Over Cable Service Interface Specifications (DOCSIS) of the CableLabs organization in the U.S. According to the DOCSIS Radio Frequency Interface (RFI) specification, modems satisfying the DOCSIS standard normally operate at a downstream signal reception power level ranging from −15 dBmV to +15 dBmV. Therefore, it is very important for a cable Internet service provider using the modem of the DOCSIS standard to maintain the downstream signal reception power level within the same range.

In other words, the DPM is a function of a cable modem monitoring the power of a downstream channel. The monitored point of the downstream channel power is the location of the F-connector of the tuner having a modem receiving a downstream signal for the first time. In order to monitor the downstream signal reception power level, a DocsIfDownstreamChannelPower field is arranged at the lower end of DocsIfDownstreamChannelEntry of Simple Network Management Protocol (SNMP). Management Information Base (MIB) information.

Most DOCSIS modems use a silicon type tuner and an Integrated Circuit (IC) performing an amplifying operation in an Intermediate Frequency (IF) band. Such an IC can be installed in a tuner or separately outside a tuner. Since a Quadrature Amplitude Modulation (QAM) demodulator chip must always receive a signal of uniform power, it sends an Automatic Gain Control (AGC) signal to a tuner and an IF amplifier IC, which is called dual AGC (Radio Frequency (RF) AGC and IF AGC). The tuner and IF amplifier IC receive the AGC signal, i.e., a control input signal, and adjust an output signal power according to the voltage level of the input AGC signal.

A digital tuner includes a tuning unit and a demodulation unit. The tuning unit includes an Automatic Gain Controller (AGC), a Radio Frequency amplifier (RF amplifier), a Radio Frequency Band Pass Filter (RF BPF), a Phase-Locked Loop Integrated Circuit (PLL IC), a local oscillator, a mixer, a Surface Acoustic Wave filter (SAW filter), an Intermediate Frequency amplifier (IF amplifier), and a Radio Frequency Automatic Gain Control detection circuit (RF AGC detection circuit). An included demodulation unit includes a demodulator IC in which an Intermediate Frequency Automatic Gain Control detection circuit (IF AGC detection circuit) is installed.

The AGC automatically controls the gain such that the output power of a video signal is always constant despite a change in the magnitude of a high-frequency signal introduced through an antenna ANT.

The RF amplifier amplifies the high-frequency signal passed through the AGC.

The RF BPF selects a desired high-frequency signal among the high-frequency signals amplified by the RF amplifier.

The PLL IC has channel data stored therein, and outputs a control voltage to the local oscillator based on external control.

The local oscillator is divided into three bands and generates a predetermined oscillation frequency according to the control voltage of the PLL IC while switching bands according to a channel frequency when a channel is selected, and outputting the oscillation frequency to the mixer.

The mixer mixes the high-frequency signal selected by the RF BPF and the oscillation frequency generated by the local oscillator to output an IF signal.

The SAW filter passes through a desired IF signal among the IF signals output from the mixer.

The IF amplifier amplifies the IF signal output from the SAW filter.

The RF AGC detection circuit controls the gain of the AGC when a strong electric field signal is input.

The demodulator IC demodulates the input IF signal and outputs the demodulated signal as a Transport Stream (TS) signal.

The IF AGC detection circuit controls the gain of the IF amplifier when a weak electric field signal is input.

The digital tuner having the configuration described above operates as follows.

First, while the signal of a high frequency band received at the antenna ANT passes through the AGC, the RF amplifier, and the RF BPF, only one broadcasting frequency is selected. The selected RF signal is mixed with the oscillation frequency generated by the local oscillator at the mixer, and then outputs an IF signal.

The local oscillator outputs the oscillation frequency to the mixer according to the control voltage of the PLL IC, and the mixer mixes the RF signal output from the RF BPF with the oscillation frequency output from the local oscillator to output the IF signal.

The IF signal output from the mixer is filtered through the SAW filter, amplified by the IF amplifier, and input to the demodulator IC which demodulates the input IF signal and outputs it as the TS signal.

When a strong electric field signal is received through the antenna ANT, the RF AGC detection circuit operates to perform automatic gain control of the AGC, and when a weak electric field signal is received, the IF AGC detection circuit operates to perform automatic gain control of the IF amplifier via the voltage output from the demodulator IC.

The digital tuner scans a channel and, when there is an RF signal RFi input to the digital tuner, detects an IF signal IFi from the input RF signal RFi.

Subsequently, the digital tuner tunes to N channels, and then checks if there is a channel having a downstream signal reception power level ranging from −15 dBmV to +15 dBmV.

When there is a channel having a downstream signal reception power level ranging from −15 dBmV to +15 dBmV, the corresponding channel is fixed, so that it is possible to receive the corresponding broadcasting.

However, when there is no channel having a downstream signal reception power level ranging from −15 dBmV to +15 dBmV, as a result of tuning to each of the N number of channels, the digital tuner performs the channel scanning process again.

Thus, in the digital broadcasting reception process noted above, first, the tuner tunes the IF input to the demodulator IC to a desired channel, i.e., a digital or analog channel, demodulates an RF signal, and then passes the demodulated RF signal through a video encoder and an audio encoder to send it to a device such as a TV having video and audio input terminals so that people can watch the broadcast. While the frequency of the desired channel is obtained by successive tuning operations, the input power of a channel can be measured. Digital Video Broadcasting (DVB), Digital Multimedia Broadcasting (DMB), Opencable, and Code Division Multiple Access (CDMA) systems each have a different input power condition.

For example, digital cable broadcasting can be watched only when the RF power in a cable is input to a Set-Top Box (STB) within the range of −15 dBmV to +15 dBmV. Therefore, cable broadcasting providers manage their whole cable networks to be supplied with a proper power. In addition, an STB is also designed to report the power of an input channel. With the reported value (Dynamic Power Management (DPM) value), cable broadcasting providers judge whether the reception power of a currently input channel is proper, and if not, input another channel using a scan algorithm, etc.

In other words, the broadcasting receiving method noted above has a problem in that when no RF signal is transmitted, e.g., when the cable is cut off, there is no signal, etc., the RF block, e.g., a tuner, etc., continues operating to find a channel even though there is no need to scan channels, and thus electricity is wasted and the overall temperature of the system increases.

In addition, when no RF signal is transmitted, e.g., when the cable is cut off, there is no signal, etc., or a problem occurs with the transmission network, the terminal cannot recognize the situation and the network manager has no way of knowing about the problem until complaints are finally received.

### SUMMARY OF THE INVENTION

It is an object of the present invention to provide a power-saving channel scanning system and method for multi-channel broadcasting that stops a scanning operation of a digital tuner installed in a broadcast receiving device (STB) when a cable is cut off or no signal is received in the system, thus preventing a waste of electricity and a temperature rise of the system.

It is another object of the present invention to provide a power-saving channel scanning system and method for managing channel power of multi-channel broadcasting in real time, thus allowing a network manager to immediately recognize the situation to maintain the network when no RF signal is transmitted or a problem occurs in the transmission network.

According to one aspect of the present invention, a power-saving channel scanning system for multi-channel broadcasting is provided, the system including: a broadcast receiving terminal adapted to: receive and measure broadcasting channel powers of at least two channels in order; and to switch from a normal mode to a power-saving mode upon a determination that all of the measured channel powers are outside a predetermined range of normal channel power.

The broadcast receiving terminal preferably includes: a tuning unit adapted to scan at least two channels in order; a channel power measurement unit adapted to measure the power of the channels scanned by the tuning unit; and a controller adapted to switch the tuning unit from the normal mode to the power-saving mode upon the determination that the powers of all of the channels measured by the channel power measurement unit are outside the predetermined range of the normal channel power.

The tuning unit switched to the power-saving mode by the controller is preferably adapted to be switched back to the normal mode in response to a system event signal and to scan every channel of a frequency band in a predetermined time.

The power-saving channel scanning system preferably further includes a monitoring device adapted to monitor the broadcasting channel power in real time and to generate an abnormal condition alarm upon a determination that the powers of all of the monitored channels are outside the predetermined range of the normal channel power.

The broadcast receiving terminal is preferably adapted to predetermine the range of the normal channel power by subtracting a predetermined value from a downstream standard signal level of a standard input signal provided by broadcasting standards and adding a predetermined value to an upstream standard signal level.

According to another aspect of the present invention, a power-saving channel scanning method for multi-channel broadcasting is provided, the method including: measuring at least two broadcasting channel powers in order; and switching a tuner scanning channels from a normal mode to a power-saving mode upon a determination that all of the measured channel powers are outside a predetermined range of a normal channel power.

The range of the normal channel power is preferably predetermined by subtracting a predetermined value from a downstream standard signal level of a standard input signal provided by broadcasting standards and adding a predetermined value to an upstream standard signal level.

The power-saving channel scanning method preferably further includes scanning channels of an entire frequency band at regular intervals upon the tuner being returned to the normal mode in response to a system event signal being generated.

According to yet another aspect of the present invention, a power-saving channel scanning method for multi-channel broadcasting is provided, the method including: monitoring at least two broadcasting channel powers in real time; and generating an abnormal transmission network condition alarm upon a determination that all of the channel powers monitored in real time are outside a predetermined range of a normal channel power.

The range of the normal channel power is preferably predetermined by subtracting a predetermined value from a downstream standard signal level of a standard input signal provided by broadcasting standards and adding a predetermined value to an upstream standard signal level.

According to still another aspect of the present invention, a power-saving channel scanning method for multi-channel broadcasting is provided, the method including: scanning at least two broadcasting channel powers in order; detecting an intermediate frequency signal from a radio frequency signal input during the scanning; and switching a tuner scanning channels from a normal mode to a power-saving mode upon a determination that all of the received channel powers of the entire frequency band are outside a predetermined range of a normal channel power as a result of tuning the channels through the detected intermediate frequency signal.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a digital tuner;

FIG. 2 is a flowchart of a channel scanning process of the digital tuner;

FIG. 3 is a schematic diagram of a power-saving channel scanning system for multi-channel broadcasting according to an embodiment of the present invention;

FIG. 4 is a block diagram of a broadcast receiving terminal of FIG. 3; and

FIG. 5 is a flowchart of a channel scanning process for multi-channel broadcasting according to an embodiment of the present invention.

### DETAILED DESCRIPTION OF THE INVENTION

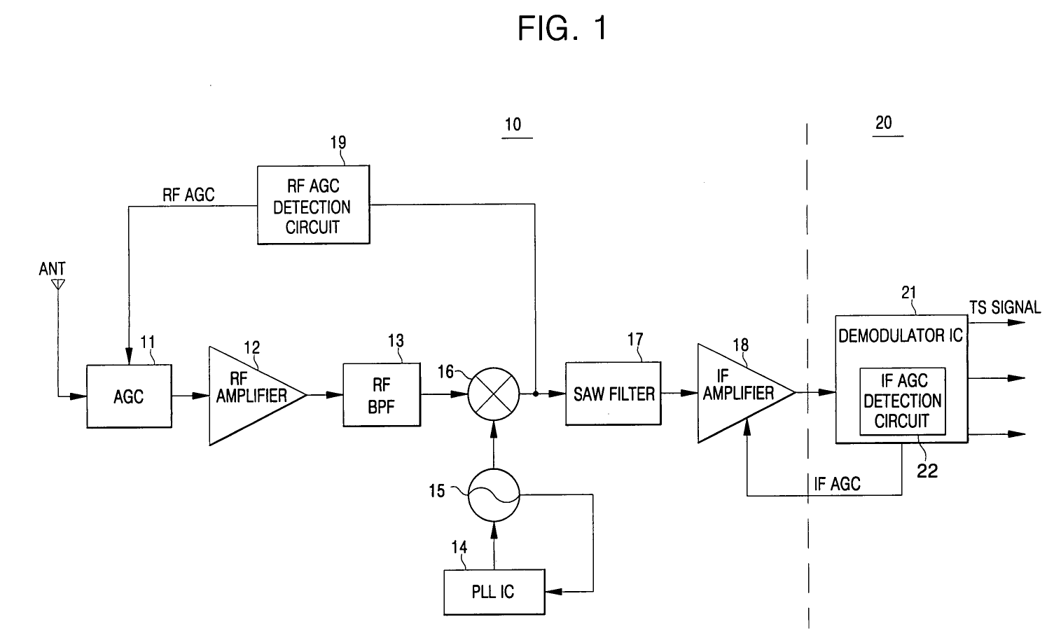

FIG. 1 is a block diagram of a digital tuner. Referring to FIG. 1, the digital tuner includes a tuning unit 10 and a demodulation unit 20. The tuning unit 10 includes an Automatic Gain Controller (AGC) 11, a Radio Frequency amplifier (RF amplifier) 12, a Radio Frequency Band Pass Filter (RF BPF) 13, a Phase-Locked Loop Integrated Circuit (PLL IC) 14, a local oscillator 15, a mixer 16, a Surface Acoustic Wave filter (SAW filter) 17, an Intermediate Frequency amplifier (IF amplifier) 18, and a Radio Frequency Automatic Gain Control detection circuit (RF AGC detection circuit) 19. An included demodulation unit 20 includes a demodulator IC 21 in which an Intermediate Frequency Automatic Gain Control detection circuit (IF AGC detection circuit) 22 is installed.

The AGC 11 automatically controls the gain such that the output power of a video signal is always constant despite a change in the magnitude of a high-frequency signal introduced through an antenna ANT.

The RF amplifier 12 amplifies the high-frequency signal passed through the AGC 11.

The RF BPF 13 selects a desired high-frequency signal among the high-frequency signals amplified by the RF amplifier 12.

The PLL IC 14 has channel data stored therein, and outputs a control voltage to the local oscillator 15 based on external control.

The local oscillator 15 is divided into three bands and generates a predetermined oscillation frequency according to the control voltage of the PLL IC 14 while switching bands according to a channel frequency when a channel is selected, and outputting the oscillation frequency to the mixer 16.

The mixer 16 mixes the high-frequency signal selected by the RF BPF 13 and the oscillation frequency generated by the local oscillator 15 to output an IF signal.

The SAW filter 17 passes through a desired IF signal among the IF signals output from the mixer 16.

The IF amplifier 18 amplifies the IF signal output from the SAW filter 17.

The RF AGC detection circuit 19 controls the gain of the AGC 11 when a strong electric field signal is input.

The demodulator IC 21 demodulates the input IF signal and outputs the demodulated signal as a Transport Stream (TS) signal.

The IF AGC detection circuit 22 controls the gain of the IF amplifier 18 when a weak electric field signal is input.

The digital tuner having the configuration described above operates as follows.

First, while the signal of a high frequency band received at the antenna ANT passes through the AGC 11, the RF amplifier 12, and the RF BPF 13, only one broadcasting frequency is selected. The selected RF signal is mixed with the oscillation frequency generated by the local oscillator 15 at the mixer 16, and then outputs an IF signal.

The local oscillator 15 outputs the oscillation frequency to the mixer 16 according to the control voltage of the PLL IC 14, and the mixer 16 mixes the RF signal output from the RF BPF 13 with the oscillation frequency output from the local oscillator 15 to output the IF signal.

The IF signal output from the mixer 16 is filtered through the SAW filter 17, amplified by the IF amplifier 18, and input to the demodulator IC 21 which demodulates the input IF signal and outputs it as the TS signal.

When a strong electric field signal is received through the antenna ANT, the RF AGC detection circuit 19 operates to perform automatic gain control of the AGC 11, and when a weak electric field signal is received, the IF AGC detection circuit 22 operates to perform automatic gain control of the IF amplifier 18 via the voltage output from the demodulator IC 21.

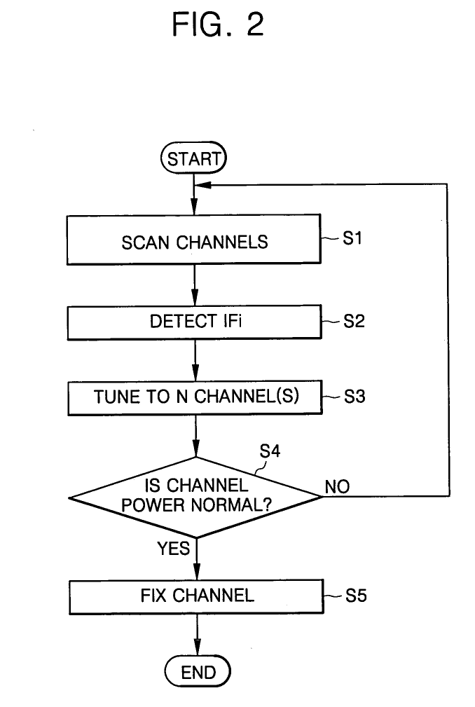

Referring to FIG. 2, a channel scanning process of the digital tuner having such a configuration will be described below.

FIG. 2 is a flowchart of a channel scanning process of the digital tuner. As shown in FIG. 2, the digital tuner scans a channel (S1) and, when there is an RF signal RFi input to the digital tuner, detects an IF signal IFi from the input RF signal RFi (S2).

Subsequently, the digital tuner tunes to N channels (S3), and then checks if there is a channel having a downstream signal reception power level ranging from −15 dBmV to +15 dBmV (S4).

When there is a channel having a downstream signal reception power level ranging from −15 dBmV to +15 dBmV, the corresponding channel is fixed (S5), so that it is possible to receive the corresponding broadcasting.

However, when there is no channel having a downstream signal reception power level ranging from −15 dBmV to +15 dBmV, as a result of tuning to each of the N number of channels, the digital tuner performs the channel scanning process again.

Hereinafter, exemplary embodiments of the present invention will be described in detail with reference to the accompanying drawings. Like elements are denoted by like reference numerals throughout the drawings. Matters related to the present invention and well-known in the art have not been described in detail when such a description would detract from the clarity of the disclosure.

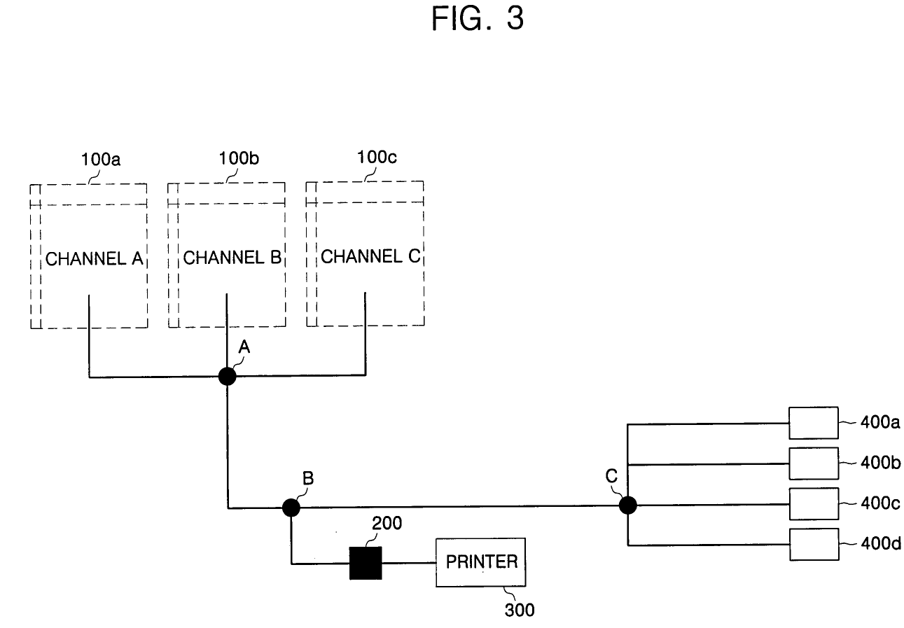

FIG. 3 is a schematic diagram of a power-saving channel scanning system for multi-channel broadcasting according to an embodiment of the present invention.

As shown in FIG. 3, the power-saving channel scanning system includes: a plurality of cable channels 100a, 100b, and 100c each providing different broadcasting services; a monitoring device 200 monitoring the reception power level of a downstream signal received from the cable channels 100a to 100c in order; a printer 300 outputting the reception power level of the downstream signal of each channel monitored by the monitoring device 200; and a plurality of broadcast receiving terminals 400a, 400b, 400c, and 400d receiving broadcasting of the cable channels 100a to 100c through an RF cable.

The cable channels 100a to 100c are channels through which a cable broadcasting station provides different cable broadcasting to the broadcast receiving terminals 400a to 400d of subscribers.

The cable broadcasting service provided by the cable channels 100a to 100c is equally distributed at a first splitter A and then provided to the broadcast receiving terminals 400a to 400d through a second splitter B and a third splitter C.

The monitoring device 200 is a Set-Top Box (STB) installed at the broadcasting station side, and monitoring the downstream signal reception power level of each of the cable channels 100a to 100c.

Specifically, the monitoring device 200 subtracts or adds a proper value α from/to the power level of a standard input signal to set up a standard value for judging the downstream and upstream signal reception power levels of each channel. As for Opencable, which is an STB standard, the standard input signal of Forward Application Transport (FAT) channels has a frequency band ranging from 54 MHz to 864 MHz, and the level of a standard input signal ranges from −15 dBmV to +15 dBmV when a 64 QAM modulation method is used, and from −12 dBmV to +15 dBmV when a 256 QAM modulation method is used.

Hereinafter, the case where the power level of the standard input signal is that of digital cable broadcasting ranging from −15 dBmV to +15 dBmV will be described below.

The monitoring device 200 adds or subtracts the value α to/from the standard input signal level of digital cable broadcasting ranging from −15 dBmV to +15 dBmV to set up the judgment standard value. Here, the value α is preferably within the range of −15 dBmV to +15 dBmV.

For example, the monitoring device 200 subtracts a value α of 15 dBmV from a standard downstream input signal level of −15 dBmV to judge the downstream signal reception power level, and adds a value α of 15 dBmV to a standard upstream input signal level of +15 dBmV to judge the upstream signal reception power level.

Thus, the monitoring device 200 monitors the downstream signal reception power level of each of the cable channels 100a to 100c in order according to the set judgment standard value, and then outputs the network condition of each monitored channel to the printer 300.

In addition, when the downstream signal reception power level of each monitored channel is beyond the set judgment standard value, the monitoring device 200 generates an alarm signal such so that a network manager or a user can immediately cope with the situation.

The printer 300 prints the network condition of each channel sent from the monitoring device 200, so that a network manager can check the condition of the network in real time and cope with an abnormal situation to restore the network to a normal condition.

The broadcast receiving terminals 400a to 400d are terminals of the subscriber side of a cable broadcasting service, mounted in an STB. They receive the broadcasting of the cable channels 100a to 100c through an RF cable.

Similar to the monitoring device 200 installed at the broadcasting station side, the broadcast receiving terminals 400a to 400d monitor the reception power level of each downstream signal received from the cable channels 100a to 100c.

Specifically, similar to the monitoring device 200, the broadcast receiving terminals 400a to 400d add or subtract the value α to/from the standard input signal level of digital cable broadcasting ranging from −15 dBmV to +15 dBmV to set up the judgment standard value. Here, the value α is preferably within the range of −15 dBmV to +15 dBmV.

For example, the broadcast receiving terminals 400a to 400d subtract a value α of 15 dBmV from a standard downstream input signal level of −15 dBmV to judge the downstream signal reception power level, and add a value α of 15 dBmV to a standard upstream input signal level of +15 dBmV to judge the upstream signal reception power level.

An example of the broadcast receiving terminals 400a to 400d judging the downstream signal reception power level will be described below.

First, the respective broadcast receiving terminals 400a to 400d compare and judge the input channel power value of the cable channels 100a to 100c input in order using the judgment standard value (ranging from −30 dBmV to +30 dBmV) set up by adding the value α to a standard input channel power.

For example, when the input channel power values of every cable channel are outside the range of −30 dBmV to +30 dBmV, the broadcast receiving terminal recognizes that no channel can be received. In this case, since an RF block, i.e., a tuning unit, need not scan channels, the broadcast receiving terminal switches the RF block from a normal mode to a power-saving mode.

When the tuning unit is in the power-saving mode, it does not perform a channel scan operation. When a system event occurs, the tuning unit is switched back from the power-saving mode to the normal mode and scans the entire frequency band at regular intervals to judge whether there is a channel to be received.

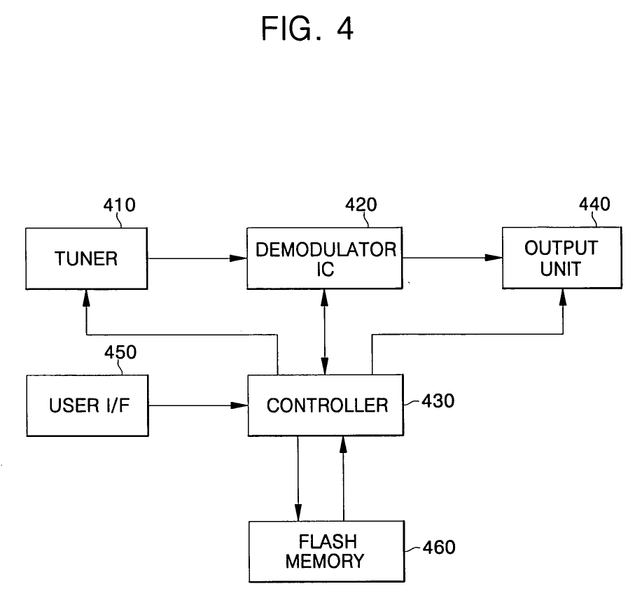

The constitution of such a broadcast receiving terminal is described in detail below with reference to FIG. 4. FIG. 4 is a block diagram of a broadcast receiving terminal of FIG. 3.

As shown in FIG. 4, the broadcast receiving terminal according to an embodiment of the present invention includes a tuner 410, a demodulator IC 420, a controller 430, an output unit 440, a user interface (user I/F) 450, and a flash memory 460.

The tuner 410 receives an RF signal digitally broadcast over a high frequency band from multiple channels, converts it into an IF signal, and then filters, amplifies, and outputs the IF signal. The tuner 410 receives channel information and RF and IF AGC values from the controller 430 to operate.

The demodulator IC 420 demodulates the IF signal sent from the tuner 410 and outputs it as a Transport Stream (TS) signal. In other words, the demodulator IC 420 tunes the IF signal input from the tuner 410 to all of the broadcasting channels to measure the channel power of an input channel frequency, and then sends the channel power to the controller 430.

The controller 430 controls the operations of the tuner 410, the demodulator IC 420, and the output unit 440 based on a user control signal input through the user interface 450 or operation information, e.g., a tuning algorithm, channel information, etc., already stored in the flash memory 460.

In addition, the controller 430 receives the channel power value measured by the demodulator IC 420, compares it with the judgment standard value set up by adding or subtracting the value α to/from the standard input signal level (ranging from −15 dBmV to +15 dBmV) of digital cable broadcasting, and then judges the downstream signal reception power level.

Specifically, the controller 430 compares the input channel power input in order from the demodulator IC 420 with the judgment standard value (ranging from −15 dBmV to +15 dBmV). When all of the input channel power values are outside the range of −30 dBmV to +30 dBmV, the controller 430 recognizes that no channel can be received and thus switches the tuner 410 from the normal mode to the power-saving mode.

When the tuner 410 is switched from the normal mode to the power-saving mode according to the control of the controller 430, the tuner 410 stops the channel scan operation for a while. In addition, the tuner 410 is switched back to the normal mode according to an event signal and scans the whole frequency band at regular intervals to judge whether there is a channel to be received.

In order to control the output power of the TS signal output from the demodulator IC 420, the output unit 440 includes a plurality of ports, e.g., an audio/video (A/V) port, a Universal Serial Bus (USB) port, an Internet port, etc.

The user interface 450 inputs the user's control signal to the controller 430.

The flash memory 460 stores the operation information, e.g., a tuning algorithm, channel information, etc., for controlling the operation of the broadcast receiving terminal.

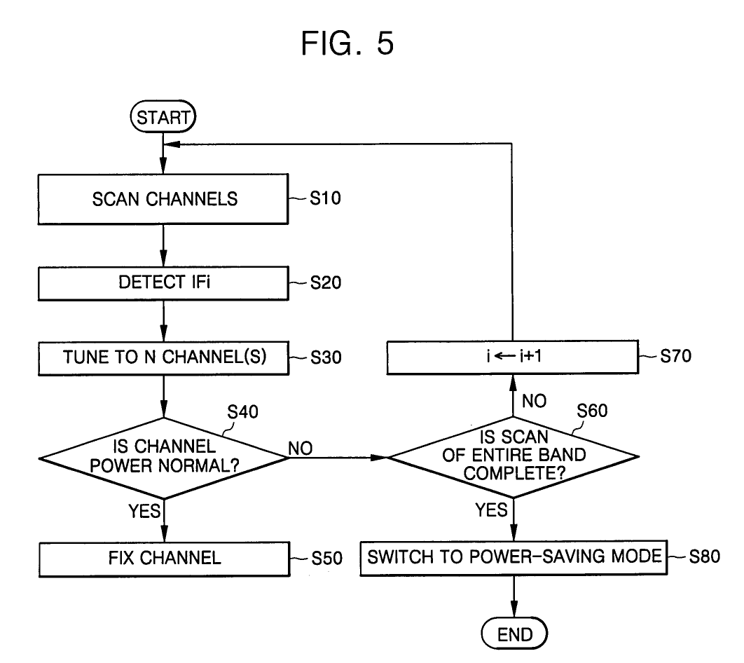

FIG. 5 is a flowchart of a channel scanning process for multi-channel broadcasting according to an embodiment of the present invention. As shown in FIG. 5, the broadcast receiving terminal scans a channel (S10) and, when an RF signal RFi is input, detects the IF signal IFi from the input RF signal RFi (S20).

Subsequently, the broadcast receiving terminal tunes to the detected IF signal of all of the broadcasting channels in order (S30), and then checks if the power value of a received channel is beyond the predetermined judgment standard value (ranging from −30 dBmV to +30 dBmV) (S40).

When the power level of the received channel is within the range of the judgment standard value (−30 dBmV to +30 dBmV), the broadcast receiving terminal is tuned to the corresponding received channel (S50) so that the corresponding broadcast can be received.

However, when the power level of the received channel is outside the range of the judgment standard value (−30 dBmV to +30 dBmV), the broadcast receiving terminal checks if the channel scan operation has been completed for every channel of the band (S60). When the channel scan operation has not been completed for every channel of the band, the broadcast receiving terminal increments the scanning channel to the next channel (S70), and then scans the channel.

However, when the channel scan operation is found to be complete for every channel of the band in S60, the broadcast receiving terminal recognizes that the input channel power values of all of the channels are outside the range of −30 dBmV to +30 dBmV and thus no channel can be received. Consequently, the broadcast receiving terminal switches the tuner, i.e., an RF module, from the normal mode to the power-saving mode (S80).

The tuner switched to the power-saving mode stops performing the channel scan operation. When a system event occurs, the tuner is switched back to the normal mode to scan all frequency bands at regular intervals to judge whether there is a channel to be received.

According to the multi-channel broadcasting system of the present invention, the digital tuner installed in the broadcast receiving device (STB) stops its scan operation when the cable is cut off or no signal is received, thus preventing a waste of electricity and a temperature rise of the system.

In addition, the multi-channel broadcasting system according to the present invention manages the channel power of multi-channel broadcasting in real time and reports it to the network manager so that the network manager can immediately know the situation and maintain the network when no RF signal is transmitted or a problem occurs in the transmission network.

While the present invention has been described with reference to exemplary embodiments thereof, it will be understood by those skilled in the art that various modifications in form and detail can be made therein without departing from the scope of the present invention as defined by the following claims.

What is claimed is:

1. A power-saving channel scanning system for multi-channel broadcasting, the system comprising:
a broadcast receiving terminal adapted to:
receive and measure broadcasting channel powers of at least two channels in order; and
to switch from a normal mode to a power-saving mode upon a determination that all of the measured channel powers are outside a predetermined range of normal channel power.

2. The power-saving channel scanning system of claim 1, wherein the broadcast receiving terminal comprises:
a tuning unit adapted to scan at least two channels in order;
a channel power measurement unit adapted to measure the power of the channels scanned by the tuning unit; and
a controller adapted to switch the tuning unit from the normal mode to the power-saving mode upon the determination that the powers of all of the channels measured by the channel power measurement unit are outside the predetermined range of the normal channel power.

3. The power-saving channel scanning system of claim 2, wherein the tuning unit switched to the power-saving mode by the controller is adapted to be switched back to the normal mode in response to a system event signal and to scan every channel of a frequency band in a predetermined time.

4. The power-saving channel scanning system of claim 1, further comprising a monitoring device adapted to monitor the broadcasting channel power in real time and to generate an abnormal condition alarm upon a determination that the powers of all of the monitored channels are outside the predetermined range of the normal channel power.

5. The power-saving channel scanning system of claim 1, wherein the broadcast receiving terminal is adapted to predetermine the range of the normal channel power by subtracting a predetermined value from a downstream standard signal level of a standard input signal provided by broadcasting standards and adding a predetermined value to an upstream standard signal level.

6. The power-saving channel scanning system of claim 2, wherein the broadcast receiving terminal is adapted to predetermine the range of the normal channel power by subtracting a predetermined value from a downstream standard signal level of a standard input signal provided by broadcasting standards and adding a predetermined value to an upstream standard signal level.

7. The power-saving channel scanning system of claim 3, wherein the broadcast receiving terminal is adapted to predetermine the range of the normal channel power by subtracting a predetermined value from a downstream standard signal level of a standard input signal provided by broadcasting standards and adding a predetermined value to an upstream standard signal level.

8. The power-saving channel scanning system of claim 4, wherein the broadcast receiving terminal is adapted to predetermine the range of the normal channel power by subtracting a predetermined value from a downstream standard signal level of a standard input signal provided by broadcasting standards and adding a predetermined value to an upstream standard signal level.

9. A power-saving channel scanning method for multi-channel broadcasting, the method comprising:
measuring at least two broadcasting channel powers in order; and
switching a tuner scanning channels from a normal mode to a power-saving mode upon a determination that all of the measured channel powers are outside a predetermined range of a normal channel power.

10. The power-saving channel scanning method of claim 9, wherein the range of the normal channel power is predetermined by subtracting a predetermined value from a downstream standard signal level of a standard input signal provided by broadcasting standards and adding a predetermined value to an upstream standard signal level.

11. The power-saving channel scanning method of claim 9, further comprising scanning channels of an entire frequency band at regular intervals upon the tuner being returned to the normal mode in response to a system event signal being generated.

12. A power-saving channel scanning method for multi-channel broadcasting, the method comprising:
monitoring at least two broadcasting channel powers in real time; and
generating an abnormal transmission network condition alarm upon a determination that all of the channel powers monitored in real time are outside a predetermined range of a normal channel power.

13. The power-saving channel scanning method of claim 12, wherein the range of the normal channel power is predetermined by subtracting a predetermined value from a downstream standard signal level of a standard input signal provided by broadcasting standards and adding a predetermined value to an upstream standard signal level.

14. A power-saving channel scanning method for multi-channel broadcasting, the method comprising:
scanning at least two broadcasting channel powers in order;
detecting an intermediate frequency signal from a radio frequency signal input during the scanning; and
switching a tuner scanning channels from a normal mode to a power-saving mode upon a determination that all of the received channel powers of the entire frequency band are outside a predetermined range of a normal channel power as a result of tuning the channels through the detected intermediate frequency signal.
